(19) United States
(12) Patent Application Publication
(10) Pub. No.: US 2009/0239975 A1
(43) Pub. Date: Sep. 24, 2009

(54) Polycarbonate Resin Composition with Good Flame Retardancy and Light Stability

(75) Inventors: Hyuk Jin JUNG, Gunpo-si (KR); Jong Cheol LIM, Anyang-si (KR); Sang Hwa LEE, Seoul (KR); Jong Yeun KIM, Seoul (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/478,867

(22) Filed: Jun. 5, 2009

Related U.S. Application Data
(63) Continuation-in-part of application No. PCT/KR2007/006967, filed on Dec. 28, 2007.

(30) Foreign Application Priority Data
Dec. 29, 2006 (KR) 2006-0138412

(51) Int. Cl. C08L 83/04

(52) U.S. Cl. 523/206; 524/506

(57) ABSTRACT

Disclosed herein is a polycarbonate resin composition having good flame retardancy and light stability which can be useful for a LCD backlight component comprising: about 60 to about 95 parts by weight of a thermoplastic polycarbonate resin, and about 5 to about 40 parts by weight of a polyethylene naphthalate-terephthalate copolymer, about 5 to about 50 parts by weight of titanium dioxide based on about 100 parts by weight of a base resin comprising the thermoplastic polycarbonate resin and the polyethylene naphthalate-terephthalate copolymer, about 0.1 to about 10 parts by weight of an organosiloxane polymer based on about 100 parts by weight of a base resin comprising the thermoplastic polycarbonate resin and the polyethylene naphthalate-terephthalate copolymer, and about 0.05 to about 5 parts by weight of a fluorinated polyolefin resin based on about 100 parts by weight of a base resin comprising the thermoplastic polycarbonate resin and the polyethylene naphthalate-terephthalate copolymer.

### CROSS-REFERENCE TO RELATED APPLICATIONS

This non-provisional application is a continuation-in-part application of PCT Application No. PCT/KR2007/006967, filed Dec. 28, 2007, pending, which designates the U.S. and which is hereby incorporated by reference in its entirety, and claims priority therefrom under 35 USC Section 120. This application also claims priority under 35 USC Section 119 from Korean Patent Application No. 10-2006-0138412, filed Dec. 29, 2006, the entire disclosure of which is also hereby incorporated by reference.

### FIELD OF THE INVENTION

The present invention relates to a polycarbonate resin composition with good flame retardancy and light stability.

### BACKGROUND OF THE INVENTION

Polycarbonate resins are engineering plastic resins having good mechanical strength, high heat resistance and transparency. Polycarbonate resins accordingly have been widely used in office automation equipment, electric/electronic components, building materials and the like.

In the field of the electric/electronic components, resins used for liquid crystalline display (LCD) backlight components should have high light reflexivity, light stability, and dyeability, among other properties. In addition, as electric/electronic goods such as televisions, monitors and notebooks are becoming increasingly slim, the resin should also exhibit high flexibility.

When a polycarbonate resin is used for backlight parts of a LCD, it is typically used as a backlight frame, made from high white colored resin in order to minimize the backlight loss in reflection. A white pigment with high white chroma such as titanium dioxide (TiO₂), which has the largest refractive index in air, is typically used to color resin.

Also, the polycarbonate resin composition should have flame retardancy. Halogen flame retardants and an antimony compound or phosphoric compound have been conventionally used as flame retardants for resins. However, halogen flame retardants emit a harmful gas during combustion, which has increased the need for a resin which does not contain a halogen flame retardant.

A representative phosphoric flame retardant is a phosphoric ester flame retardant. However, a resin composition including a phosphoric ester flame retardant can exhibit “juicing,” in which the flame retardant migrates to the surface of a molded article and deposits there during molding. Also, heat resistance of the resin composition can rapidly decrease.

Sulfonate metal salts are commonly used to impart high heat resistance and flame retardancy without using a halogen flame retardant. However, flame retardancy and mechanical properties of the resin composition can be reduced due to degradation of the resin at high temperature when the resin also includes a large amount of titanium dioxide to provide a high white color.

Japanese Patent Publication No. H9-012853 discloses a flame retardant resin composition comprising a polycarbonate resin, titanium dioxide, a polyorganosiloxane-poly(meth)acrylate rubber complex, flame retardants and polytetrafluoroethylene. U.S. Pat. No. 5,837,757 discloses a flame retardant resin composition comprising a polycarbonate resin, titanium dioxide, a stilbene-bisbenzoxazole derivative, and a non-halogen phosphate compound. However, these compositions can exhibit decreased light reflexibility due to yellowing resulting from the degradation of the resin composition accelerated by halogen and phosphoric ester flame retardants when the resin contacts a light source over a period of time. Light reflexibility is also referred to as light stability.

In order to solve the above problem, U.S. Pat. No. 6,664,313 discloses a flame retardant resin composition comprising an aromatic polycarbonate resin, titanium oxide, silica, a polyorganosiloxane polymer, and polytetrafluoroethylene. However, impact resistance and appearance of the molded article can deteriorate due to the silica flame retardant.

### SUMMARY OF THE INVENTION

The present invention provides a resin composition with good flame retardancy and light stability without deterioration of impact resistance (or impact strength) and heat resistance (or thermal stability). The polycarbonate resin composition can also exhibit good processability and appearance. The thermoplastic resin composition with good flame retardancy and light stability can accordingly be useful for LCD backlight components.

The polycarbonate resin composition of the present invention useful for LCD backlight components and having good flame retardancy and light stability includes (A) about 60 to about 95 parts by weight of a thermoplastic polycarbonate resin and (B) about 5 to about 40 parts by weight of a thermoplastic polyethylene naphthalate-terephthalate copolymer, and with regard to about 100 parts by weight of the base resin comprising (A)+(B), (C) about 5 to about 50 parts by weight of titanium dioxide, (D) about 0.1 to about 10 parts by weight of an organosiloxane polymer and (E) about 0.05 to about 5 parts by weight of a fluorinated polyolefin resin.

In an exemplary embodiment, the polycarbonate resin composition can have a flame retardancy of V-0 measured in accordance with UL-94 at a sample thickness of 2.0 mm, an impact strength of about 20 kgf·cm/cm or more at a sample thickness of ⅛″ measured in accordance with ASTM D256, a vicat softening temperature of about 125° C. or higher measured in accordance with ASTM D1525, and a difference in yellow index of about 20 or less measured by a ASTM G53 UV Condensation machine and Minolta 3600D CIE Lab. Color difference meter, before and after UV irradiation.

The present invention further provides a molded article and a LCD backlight component extruded from said resin composition.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

### (A) Polycarbonate Resin

The polycarbonate resin (A) used in the resin composition of the present invention may be an aromatic polycarbonate resin. The aromatic polycarbonate resin can be prepared by reacting a phosgene, halogen formate or carbonic diester with a diphenol represented by the following chemical formula 1:

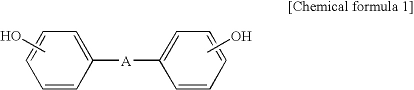

wherein A is a single bond, C₁-C₅ alkylene, C₁-C₅ alkylidene, C₅-C₆ cycloalkylidene, —S— or —SO₂—.

Examples of diphenols of chemical formula 1 may include without limitation hydroquinone, resorcinol, 4,4′-dihydroxydiphenyl, 2,2-bis-(4-hydroxyphenyl)-propane (also referred to as “bisphenol A”), 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, 2,2-bis-(3,5-dichloro-4-hydroxyphenyl)-propane and the like, and combinations thereof. In exemplary embodiments, the aromatic polycarbonate used in the present invention is primarily made of bisphenol A.

A suitable polycarbonate for the resin composition of the present invention can have a weight average molecular weight of about 10,000 to about 200,000, for example about 15,000 to about 80,000.

The polycarbonate can be a linear or branched polycarbonate, a polyester carbonate copolymer resin, or a combination thereof. The branched polycarbonate can be prepared using about 0.05 to about 2 mol % of a tri- or higher multifunctional compound, such as a compound having three or more phenolic groups, based on the total amount of diphenol used in polymerization. The polyester-carbonate copolymer resin may be prepared by polymerizing polycarbonate in the presence of an ester precursor, such as dicarboxylic acid.

Examples of the polycarbonate of the resin composition of the present invention can further include without limitation homopolycarbonates, copolycarbonates, and combinations thereof.

### (B) Polyethylene Naphthalate-Terephthalate Copolymer

The polyethylene naphthalate-terephthalate copolymer (B) of the present invention can be prepared by esterificating or transesterificating ethylene glycol with 2,6-naphthalene dicarboxylate or 2,6-naphthalene dicarboxylic acid and adding dimethyl terephthalate or terephthalic acid at the beginning of the reaction, while maintaining the reaction conditions the same as in the polymerization of polyethylene naphthalate homopolymer.

The polyethylene naphthalate-terephthalate copolymer used in the resin composition of the present invention can be represented by the following chemical formula 2 and any of a random-, block- or segmented block copolymer, or a combination thereof, may be used.

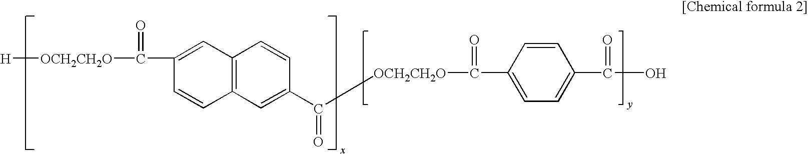

wherein x and y are integers indicating the repeating unit of ethylene naphthalate and ethylene terephthalate, respectively.

The polyethylene naphthalate-terephthalate copolymer used in the present invention can have a x:y ratio of about 2:98 to about 98:2, for example about 50:50 to about 95:5, and as another example about 90:10 to about 98:2.

The polyethylene naphthalate-terephthalate copolymer used in the present invention may have an intrinsic viscosity [η] in the range of about 0.36 to about 1.60, for example about 0.52 to about 1.25, as measured in a solvent of o-chlorophenol at a temperature of about 25° C. When the intrinsic viscosity is less than about 0.36, mechanical properties may deteriorate. If the intrinsic viscosity is more than about 1.60, moldability may deteriorate.

In the present invention, the polycarbonate resin (A) and the polyethylene naphthalate-terephthalate copolymer (B) comprise a base resin and may be present in an amount of about 60 to about 95 parts by weight and about 5 to about 40 parts by weight, respectively. When used within the above ranges, it can be possible to obtain desired flame retardancy and impact strength. In exemplary embodiments, the base resin can include the polycarbonate resin (A) in an amount of about 65 to about 90 parts by weight and the polyethylene naphthalate-terephthalate copolymer (B) in an amount of about 10 to about 35 parts by weight.

### (C) Titanium Dioxide

In the present invention, any conventional titanium dioxide regardless of its preparation method or particle diameter can be used.

Exemplary titanium dioxide includes titanium dioxide surface-treated with an organic or an inorganic surface treatment agent. Examples of inorganic surface treatment agents may include without limitation aluminum oxide (alumina, Al₂O₃), silicon dioxide (silica, SiO₂), zirconia (zirconium dioxide, ZrO₂), sodium silicate, sodium aluminate, sodium aluminum silicate, zinc oxide, mica and the like. The inorganic surface treatment agents can be used singly or in combination with one another. The inorganic surface treatment agent may be used in an amount of about 2 parts by weight or less based on about 100 parts by weight of titanium dioxide.

Examples of the organic surface treatment agents may include without limitation polydimethyl siloxane, trimethylolpropane (TMP), pentaerythritol and the like. The organic surface treatment agents can be used singly or in combination with one another. The organic surface treatment agent may be used in an amount of about 0.3 parts by weight or less based on about 100 parts by weight of titanium dioxide.

In exemplary embodiments, the titanium dioxide may be coated with alumina (Al₂O₃) in an amount of about 2 parts by weight or less based on about 100 parts by weight of titanium dioxide.

Also, the alumina-coated titanium dioxide can be further treated with inorganic surface treatment agents such as silicon dioxide, zirconium dioxide, sodium silicate, sodium aluminate, sodium aluminum silicate, mica, and the like and combinations thereof, or organic surface treatment agents such as polydimethyl siloxane, trimethylolpropane (TMP) and pentaerythritol, and the like, and combinations thereof.

The titanium dioxide (C) of the present invention may be used in an amount of about 5 to about 50 parts by weight, for example about 10 to about 35 parts by weight, and as another example about 15 to about 30 parts by weight, based on about 100 parts by weight of the base resin. A composition of the invention including titanium dioxide in the above ranges can exhibit desired light reflectivity and impact resistance.

### (D) Organosiloxane Polymer

The organosiloxane polymer (D) of the present invention can be represented by the following chemical formula 3.

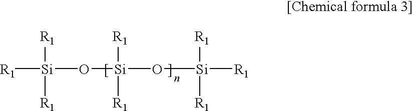

wherein each R₁ is independently C₁-C₈ alkyl, C₆-C₃₆ aryl or C₁-C₁₅alkyl substituted C₆-C₃₆ aryl, and n is a repeating unit and is an integer in the range of 1≦n<10,000.

Examples of the organosiloxane polymer (D) may include, but are not limited to, polydimethylsiloxane, poly(methylphenyl) siloxane, poly(diphenyl) siloxane, dimethylsiloxane-diphenyl siloxane copolymer, dimethylsiloxane-methylphenylsiloxane copolymer, and the like, and combinations thereof.

In the present invention, the organosiloxane polymer (D) may be used as a flame retardant. The organosiloxane polymer (D) can be used in an amount of about 0.1 to about 10 parts by weight, for example about 0.5 to about 7 parts by weight, and as another example about 0.7 to about 5 parts by weight, based on about 100 parts by weight of the base resin in order to obtain a desirable balance of properties.

### (E) Fluorinated Polyolefin Resin

The fluorinated polyolefin resin functions to form a fibrillar network in the resin composition when the resin composition is extruded, thereby decreasing melt viscosity of the resin composition and increasing shrinkage during combustion so as to prevent the dripping phenomena.

Examples of the fluorinated polyolefin resin (E) may include without limitation polytetrafluoroethylene, polyvinylidene fluoride, tetrafluoroethylene/vinylidene fluoride copolymer, tetrafluoroethylene/hexafluoropropylene copolymer, ethylene/tetrafluoroethylene copolymer and the like. The fluorinated polyolefin resins can be used singly or in combination.

The fluorinated polyolefin resin can be prepared via polymerization techniques known in the art. According to exemplary embodiments, the fluorinated polyolefin resin can be prepared in an aqueous medium under a pressure from about 7 and about 71 kg/cm² at a temperature from about 0 and about 200° C., for example about 20 and about 100° C., in the presence of a free radical-forming catalyst such as sodium, potassium or ammonium peroxydisulfate, and the like. The fluorinated polyolefin resin can be used in an emulsive or powder state. When used as an emulsion, dispersion of the fluorinated polyolefin resin may be good, but the process can be complicated. Accordingly, exemplary embodiments of the invention use a powder form of the fluorinated polyolefin resin to uniformly disperse it in the entire resin composition to form the fibrillar network structure.

According to exemplary embodiments, the fluorinated polyolefin resin may be polytetrafluoroethylene having an average particle size from about 0.05 and about 1,000 μm and a density from about 1.2 and about 2.3 g/cm³.

The fluorinated polyolefin resin (E) can be used in an amount of about 0.05 to about 5 parts by weight, for example about 0.1 to about 3.5 parts by weight, and as another example about 0.3 to about 2 parts by weight, in order to obtain a desirable balance of physical properties.

The polycarbonate resin composition of the present invention with good light reflexibility may further include other additives depending on the particular use of the composition. Examples of such additives may include without limitation UV stabilizers, fluorescent whitening agents, lubricants, releasing agents, nucleating agents, antistatic agents, stabilizers, reinforcing agents, inorganic fillers, pigments or dyes and the like, and combinations thereof. The foregoing additives may be used in an amount from about 0 to about 60 parts by weight, for example from about 1 to about 40 parts by weight, per about 100 parts by weight of the base resin.

In exemplary embodiments, the UV stabilizers may be without limitation benzotriazole-based, benzophenone-based or triazine-based stabilizers, or a combination thereof, represented by the following chemical formulas 4, 5 and 6, respectively.

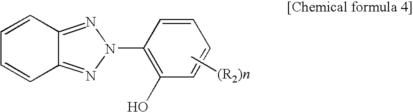

wherein each R₂ is independently C₁-C₁₀ alkyl or C₁-C₁₅ alkyl-substituted phenyl, and n is 1 or 2.

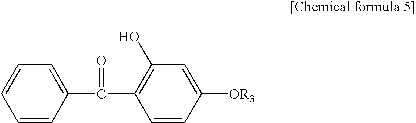

wherein R₃ is hydrogen, methyl, or C₁-C₁₅ alkyl-substituted phenyl.

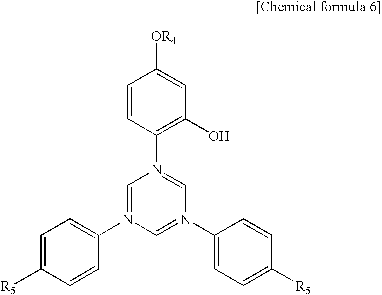

wherein R₄ is hydrogen, C₁-C₁₈ alkyl, C₂-C₆ halogen-substituted alkyl, C₁-C₁₂ alkoxy or benzyl, and each R₅ is independently hydrogen or methyl.

The fluorescent whitening agent can be a stilbene-bisbenzoxazole derivative which can generally act to enhance the light reflexibility of the polycarbonate resin composition. Examples of the stilbene-bisbenzoxazole derivatives may include, but are but not limited to, 4-(benzoxazol-2-yl)-4′-(5-methylbenzoxazol-2-yl)stilbene[4-(benzoxazole-2-yl)-4′-(5-methylbenzoxazol-2-yl)stilbene], 4,4′-bis(benzoxazol-2-yl)stilbene[4,4′-bis(benzoxazole-2-yl)stilbene] and the like, and combinations thereof.

The resin composition according to the present invention can be prepared by a conventional process for preparing a resin composition. For example, all the components and additives can be mixed together and extruded through an extruder and can be prepared in the form of pellets.

In exemplary embodiments, the polycarbonate resin composition can have a flame retardancy of V-0 measured in accordance with UL-94 at a sample thickness of 2.0 mm, an impact strength of about 20 kgf·cm/cm or more at a sample thickness of ⅛″ measured in accordance with ASTM D256, a vicat softening temperature of about 125° C. or higher measured in accordance with ASTM D1525, and a difference in yellow index of about 20 or less measured by ASTM G53 UV Condensation machine and Minolta 3600D CIE Lab. Color difference meter, before and after UV irradiation.

The resin composition of the present invention can have excellent impact resistance, heat resistance, flame retardancy and light stability and accordingly can be useful in the preparation of a molded component in which light stability is required.

For example, the resin composition of the present invention can be particularly suitable for backlight components for LCDs because of its good light reflexibility and flame retardancy, and excellent mechanical strength without deterioration of workability.

The invention may be better understood by reference to the following examples that are intended for the purpose of illustration and are not to be construed as in any way limiting the scope of the invention. In the following examples, all parts and percentage are by weight unless otherwise indicated.

### EXAMPLES

### (A) Polycarbonate Resin

Bisphenol A-based polycarbonate having a weight average molecular weight of 25,000 g/mol manufactured by Teijin Corp. of Japan (product name: PANLITE L-1250WP) is used.

### (B) Polyethylene Naphthalate-Terephthalate Copolymer

A polyethylene naphthalate-terephthalate copolymer having an intrinsic viscosity [η] of 0.83 and represented by the above Chemical Formula 2 in which the ratio of x to y is 92:8 manufactured by Kolon Corp. of Korea (product name: NOPLA KE-931) is used.

### (B-1) Polyethylene Naphthalate Homopolymer

A polyethylene naphthalate homopolymer having an intrinsic viscosity [η] of 0.9 is used.

### (B-2) Polyethylene Terephthalate Homopolymer

A polyethylene terephthalate homopolymer having an intrinsic viscosity [η] of 1.6 manufactured by Anychem Corp. of Korea (product name: ANYPET 1100) is used.

### (C) Titanium Dioxide

Titanium dioxide, TI-PURE R-106 (Dupont, USA) is used.

### (D) Organosiloxane Polymer

Polymethylphenylsiloxane oil manufactured by GE-Toshiba Silicon Corp. (product name: TSF-433) is used as a flame retardant.

### (D-1) Bisphenol A-Derivated Oligomer Type Phosphoric Ester

Bisphenol-A derivative oligomer type phosphoric ester manufactured by Daihachi Company of Japan (product name: CR-741) is used as a flame retardant.

### (D-2) Resorcinol-Derivated Oligomer Type Phosphoric Ester

Resorcinol-derivated oligomer type phosphoric ester manufactured by Daihachi Company of Japan (product name: PX-200) is used as a flame retardant (D-2).

### (D-3) Sulfonic Acid Metal Salt

Sulfonic acid metal salt manufactured by 3M Company of U.S.A. (product name: FR-2025) is used as a flame retardant.

### (E) Fluorinated Polyolefin Resin

Teflon™ 7AJ (Dupont, USA) is used.

### Examples 1-3 and Comparative Examples 1-7

The components as shown in Table 1 along with antioxidants and thermal stabilizers are mixed in a conventional mixer and the mixture is extruded through a twin screw extruder (L/D=35, φ=45 mm) into pellets. The resin pellets are molded into test specimens using a 10 oz injection molding machine at 280-300° C. The properties of these test specimens are measured in accordance with ASTM standards as described below after leaving the specimens at 23° C. and 50% relative humidity for 48 hours. The results are shown in the following Table 1.

### Physical Properties

(1) Flame retardancy: The flame retardancy is measured in accordance with UL-94 regulations using 2.0 mm thick test specimens.

(2) Notch Izod impact strength: The impact strength is measured in accordance with ASTM D256 using ⅛″ test specimens.

(3) Vicat softening temperature: The vicat softening temperature is measured in accordance with ASTM D1525.

(4) Light stability: The light stability is evaluated as the yellow index measured by ASTM G53 UV Condensation machine and Minolta 3600D CIE Lab. Color difference meter, before and after UV irradiation.

TABLE 1

| | | Examples | | | Comparative Examples | | | | | | |
|---|---|---|---|---|---|---|---|---|---|---|---|
| | | 1 | 2 | 3 | 1 | 2 | 3 | 4 | 5 | 6 | 7 |
| (A) Polycarbonate resin | | 80 | 60 | 90 | 100 | 80 | 80 | 80 | 80 | 80 | 30 |
| Polyester resin | (B) | 20 | 40 | 10 | — | — | — | 20 | 20 | 20 | 70 |
| | (B-1) | — | — | — | — | 20 | — | — | — | — | — |
| | (B-2) | — | — | — | — | — | 20 | — | — | — | — |
| (C) Titanium dioxide | | 20 | 20 | 30 | 20 | 20 | 20 | 20 | 20 | 20 | 20 |
| Flame | (D) | 2 | 3 | 2 | 2 | 2 | 2 | — | — | — | 2 |
| retardant | (D-1) | — | — | — | — | — | — | 7 | — | — | — |
| | (D-2) | — | — | — | — | — | — | — | 5 | — | — |
| | (D-3) | — | — | — | — | — | — | — | — | 0.1 | — |

| (E) Fluorinated | | 0.5 | 0.5 | 0.5 | 0.5 | 0.5 | 0.5 | 0.5 | 0.5 | 0.5 | 0.5 |
|---|---|---|---|---|---|---|---|---|---|---|---|
| polyolefin resin | | | | | | | | | | | |
| UL 94 flame retardancy | | V-0 | V-0 | V-0 | V-0 | V-0 | V-2 | V-1 | V-1 | Fail | Fail |
| (2.0 mm) | | | | | | | | | | | |
| Total combustion time | | 24 | 30 | 21 | 24 | 25 | — | 64 | 61 | — | — |
| (second) | | | | | | | | | | | |
| Izod impact strength | | 30 | 25 | 35 | 37 | 13 | 31 | 9 | 10 | 14 | 6 |
| (⅛″, kgfcm/cm) | | | | | | | | | | | |
| Vicat softening | | 135 | 130 | 139 | 141 | 135 | 133 | 108 | 110 | 134 | 114 |
| temperature (° C.) | | | | | | | | | | | |
| Light | Before UV | 2.4 | 2.0 | 2.6 | 3.6 | 2.3 | 3.2 | 2.6 | 2.5 | 2.7 | 0.7 |
| stability | irradiation | | | | | | | | | | |
| (yellow | 72 hours | 19.9 | 16.4 | 20.5 | 27.0 | 20.0 | 21.5 | 30.1 | 28.4 | 27.9 | 15.2 |
| index) | after UV | | | | | | | | | | |
| | irradiation | | | | | | | | | | |
| | Difference | 17.5 | 14.4 | 17.9 | 23.4 | 17.7 | 18.3 | 27.5 | 25.9 | 25.2 | 14.5 |
| | in yellow | | | | | | | | | | |
| | index | | | | | | | | | | |

Comparative Example 1, which does not include component (B), has deteriorated light stability, although flame retardancy, impact strength and heat resistance are good.

Comparative Examples 2 and 3 are prepared in the same manner as Example 1 except that components (B-1) and (B-2), respectively, are used instead of the polyester (B). As shown in Table 1, Comparative Example 2 exhibits poor impact strength, although it has good flame retardancy and light stability. Comparative Example 3 exhibits poor flame retardancy, although it has good impact resistance Comparative Examples 4, 5, and 6 are prepared in the same manner as Example 1 except that components (D-1), (D-2) and (D-3), respectively, are used instead of the flame retardant (D). As shown in Table 1, Comparative Examples 4 and 5 have significantly deteriorated flame retardancy, impact strength and light stability. Comparative Example 6 has good heat resistance but significantly deteriorated flame retardancy, impact strength and light stability.

Comparative Example 7 is prepared using components (A) and (B) in amounts outside of the range of the present invention. As shown in Table 1, Comparative Example 7 has significantly deteriorated the flame retardancy and impact strength.

The results in Table 1 demonstrate that the resin composition of the present invention including polycarbonate resin, polyethylene naphthalate-terephthalate copolymer, surface-treated titanium dioxide, organosiloxane copolymer and fluorinated polyolefin resin in the amounts described herein exhibits smaller color change after UV-radiation without deterioration of flame retardancy, IZOD impact strength and heat resistance as compared with compositions including each component alone or in an amount outside of the ranges of the present invention.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A polycarbonate resin composition with good flame retardancy and light stability comprising:
(A) about 60 to about 95 parts by weight of a thermoplastic polycarbonate resin;
(B) about 5 to about 40 parts by weight of a polyethylenenaphthalate-terephthalate copolymer;
(C) about 5 to about 50 parts by weight of a titanium dioxide, based on about 100 parts by weight of a base resin comprising (A)+(B);
(D) about 0.1 to about 10 parts by weight of an organosiloxane polymer represented by the following chemical formula 3, based on about 100 parts by weight of a base resin comprising (A)+(B): 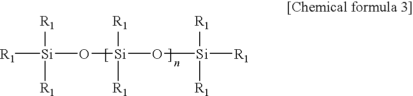
wherein each R₁ is independently C₁-C₈ alkyl, C₆-C₃₆ aryl or C₁-C₁₅ alkyl-substituted aryl, and n is an integer from 1≦n<10,000; and
(E) about 0.05 to about 5 parts by weight of a fluorinated polyolefin resin, based on about 100 parts by weight of a base resin comprising (A)+(B).

2. The polycarbonate resin composition with good flame retardancy and light stability of claim 1, wherein said polyethylene naphthalate-terephthalate copolymer is represented by the following chemical formula 2: 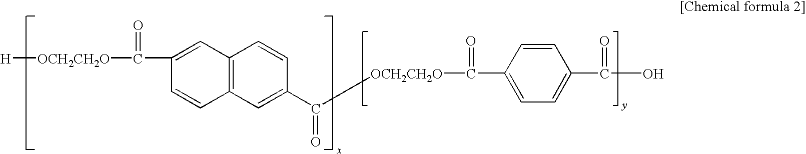
wherein x and y are integers indicating the repeating unit of ethylene naphthalate and ethylene terephthalate, respectively.

3. The polycarbonate resin composition with good flame retardancy and light stability of claim 2, wherein the mol % ratio of x and y indicating the repeating unit of ethylene naphthalate and ethylene terephthalate is about 2:98 to about 98:2.

4. The polycarbonate resin composition with good flame retardancy and light stability of claim 1, wherein said titanium dioxide (C) is surface-treated with an inorganic surface treatment agent or an organic surface treatment agent.

5. The polycarbonate resin composition with good flame retardancy and light stability of claim 4, wherein said titanium dioxide is surface-treated with about 0.3 parts by weight or less of the organic surface-treatment agent, based on about 100 parts by weight of the titanium dioxide.

6. The polycarbonate resin composition with good flame retardancy and light stability of claim 5, wherein said organic surface-treatment agent comprises polydimethylsiloxane, trimethylolpropane (TMP), pentaerythritol, or a combination thereof.

7. The polycarbonate resin composition with good flame retardancy and light stability of claim 4, wherein said titanium dioxide is surface-treated with about 2 parts by weight or less of the inorganic surface-treatment agent, based on about 100 parts by weight of the titanium dioxide.

8. The polycarbonate resin composition with good flame retardancy and light stability of claim 7, wherein said inorganic surface-treatment agent comprises aluminum oxide, silicon dioxide, zirconium dioxide, sodium silicate, sodium aluminate, sodium aluminum silicate, zinc oxide, mica, or a combination thereof.

9. The polycarbonate resin composition with good flame retardancy and light stability of claim 7, wherein said titanium dioxide is surface-treated with the aluminum oxide and further treated with an inorganic surface-treatment agent comprising silicon dioxide, zirconium dioxide, sodium silicate, sodium aluminate, sodium aluminum silicate, mica, or a combination thereof, or an organic surface treatment agent comprising polydimethylsiloxane, trimethylolpropane (TMP), pentaerythritol, or a combination thereof.

10. The polycarbonate resin composition with good flame retardancy and light stability of claim 1, wherein said organosiloxane polymer comprises polydimethylsiloxane, poly(methyl phenyl)siloxane, poly(diphenyl)siloxane, dimethylsiloxane-diphenylsiloxane copolymer, dimethylsiloxane-methylphenylsiloxane copolymer, or a combination thereof.

11. The polycarbonate resin composition with good flame retardancy and light stability of claim 1, further comprising an additive comprising a UV stabilizer, fluorescent whitening agent, lubricant, releasing agent, nucleating agent, antistatic agent, stabilizer, reinforcing agent, inorganic filler, pigment, dye, or a combination thereof in an amount of about 60 parts by weight or less based on about 100 parts by weight of the base resin comprising (A)+(B).

12. The polycarbonate resin composition of claim 1, wherein said polycarbonate resin composition has a flame retardancy of V-0 measured in accordance with UL-94 at a sample thickness of 2.0 mm, an impact strength of about 20 kgfcm/cm or more at a sample thickness of ⅛″ measured in accordance with ASTM D256, a vicat softening temperature of about 125° C. or higher measured in accordance with ASTM D1525, and a difference in yellow index of about 20 or less measured by ASTM G53 UV Condensation machine and Minolta 3600D CIE Lab. Color difference meter, before and after UV irradiation.

13. A molded article extruded from the polycarbonate resin composition as defined in claim 1.

14. A LCD backlight component molded from the polycarbonate resin composition as defined in claim 1.
